(19) United States
(12) Patent Application Publication
(10) Pub. No.: US 2015/0170406 A1
(43) Pub. Date: Jun. 18, 2015

(54) GRAPHIC PROCESSING UNIT, SYSTEM-ON-CHIP INCLUDING GRAPHIC PROCESSING UNIT, AND GRAPHIC PROCESSING SYSTEM INCLUDING GRAPHIC PROCESSING UNIT

(71) Applicants: Chang Hyo Yu, Yongin-si (KR); Seok Hoon Kim, Suwon-si (KR)

(72) Inventors: Chang Hyo Yu, Yongin-si (KR); Seok Hoon Kim, Suwon-si (KR)

(21) Appl. No.: 14/550,099

(22) Filed: Nov. 21, 2014

(30) Foreign Application Priority Data
Dec. 13, 2013 (KR) 10-2013-0155734

(51) Int. Cl. G06T 15/40

(52) U.S. Cl. CPC G06T 15/405

(57) ABSTRACT

A graphic processing unit includes a primitive assembler configured to produce position information of a first primitive and position information of a second primitive; and a visibility tester configured to perform a visibility test based on position information of the second primitive and triangle correlation information of the first primitive, and, prior to operating a rasterizer, remove the second primitive based on a result of the visibility test.

### CROSS-REFERENCE TO RELATED APPLICATIONS

This U.S. non-provisional application claims priority under 35 U.S.C. §119 Korean Patent Application No. 10-2013-0155734, filed on Dec. 13, 2013, in the Korean Intellectual Property Office, the contents of which are herein incorporated by reference in their entirety.

### BACKGROUND

The example embodiments of the present inventive concepts relate to a graphic processing unit (GPU), a system-on-chip (SoC) including the GPU, and a data processing system including the graphic processing unit. More particularly, the example embodiments of the present inventive concepts relate to a GPU capable of reducing the amount of calculation and power consumption and a method of operating the same.

GPUs are configured to render an image of an object to be displayed on a display. Recently, GPUs have been developed to perform a tessellation operation and geometry shading so as to more finely express an image of an object to be displayed on a display during a process of rendering the image of the object.

A GPU may produce a plurality of primitives for an image of an object to be displayed by performing the tessellation operation and the geometry shading, and perform an additional operation on the plurality of primitives. However, the amount of calculation required by the GPU to perform the additional operation is considerably high, thereby greatly increasing power consumption.

### SUMMARY

The example embodiments of the present inventive concepts provide a graphic processing unit (GPU) capable of decreasing the amount of calculation and power consumption by removing invisible primitives beforehand based on some information regarding the primitives, a system-on-chip (SoC) including the GPU, and a data processing system including the GPU.

According to an aspect of the present inventive concepts, a GPU includes a primitive assembler configured to produce position information of a first primitive and position information of a second primitive; and a visibility tester configured to perform a visibility test based on triangle correlation information of the first primitive and the position information of the second primitive, and, prior to operating a rasterizer, remove the second primitive based on a result of the visibility test.

In some embodiments, the position information of the first primitive may include X, Y, and Z coordinates of each vertex of the first primitive, and the position information of the second primitive may include X, Y, and Z coordinates of each vertex of the second primitive.

In some embodiments, the visibility tester may determine whether the second primitive is included in the first primitive, based on the position information of the second primitive and the position information and the triangle correlation information of the first primitive, and, when it is determined that the second primitive is included in the first primitive, compare the Z coordinates of the vertices of the first primitive with the Z coordinates of the vertices of the second primitive.

In some embodiments, the GPU may further include an update determination unit configured to determine whether the position information of the second primitive is to be stored in a visibility buffer based on the result of the visibility test; and an update unit configured to store information regarding the second primitive in the visibility buffer based on a result of determining whether the position information of the second primitive is to be stored in the visibility buffer.

In some embodiments, the GPU may further include a triangle setup unit configured to produce triangle correlation information of the second primitive from the position information of the second primitive and transmit the triangle correlation information to the visibility buffer or the update unit based on the result of determining whether the position information of the second primitive is to be stored in the visibility buffer.

In some embodiments, the GPU may further include an initial triangle setup unit configured to produce triangle correlation information of the second primitive from the position information of the second primitive based on the result of determining whether the position information of the second primitive is to be stored in the visibility buffer.

In some embodiments, the GPU may further include a triangle setup unit configured to receive the triangle correlation information of the second primitive and produce triangle setup information of the second primitive.

In some embodiments, the update determination unit may compare an area of the second primitive with a threshold area, compare an X-axis length of the second primitive with a threshold X-axis length, and compare a Y-axis length of the second primitive with a threshold Y-axis length.

In some embodiments, in order to store the information regarding the second primitive in the visibility buffer based on the result of determining whether the position information of the second primitive is to be stored in the visibility buffer, the update unit may store the information regarding the second primitive in the visibility buffer based on at least one of whether a screen space is divided into a plurality of regions, an inclusive relationship between the second primitive and the plurality of regions of the screen space, and a hierarchical relationship between the plurality of regions of the screen space.

According to another aspect of the present inventive concepts, a GPU includes a primitive assembler configured to produce position information of a first primitive and position information of a second primitive; a visibility tester configured to perform a visibility test based on triangle correlation information of the first primitive and the position information of the second primitive stored in a visibility buffer, and, prior to operating a rasterizer, remove the second primitive based on a result of the visibility test; an update determination unit configured to determine whether the position information of the second primitive is to be stored in the visibility buffer based on the result of the visibility test; and an update unit configured to store information regarding the second primitive in the visibility buffer based on a result of determining whether the position information of the second primitive is to be stored in the visibility buffer.

In some embodiments, the position information of the first primitive may include X, Y, and Z coordinates of each vertex of the first primitive, and the position information of the second primitive may include X, Y, and Z coordinates of each vertex of the second primitive.

In some embodiments, the visibility tester may determine whether the second primitive is included in the first primitive based on the position information of the second primitive and the position information and the triangle correlation information of the first primitive, and, when it is determined that the second primitive is included in the first primitive, compare the Z coordinates of the vertices of the first primitive with the Z coordinates of the vertices of the second primitive.

In some embodiments, the GPU may further include a triangle setup unit configured to produce triangle correlation information of the second primitive from the position information of the second primitive and transmit the triangle correlation information to the visibility buffer or the update unit based on the result of determining whether the position information of the second primitive is to be stored in the visibility buffer.

In some embodiments, the GPU may further include an initial triangle setup unit configured to produce triangle correlation information of the second primitive from the position information of the second primitive based on the result of determining whether the position information of the second primitive is to be stored in the visibility buffer.

In some embodiments, the GPU may further include a triangle setup unit configured to receive the triangle correlation information of the second primitive and produce triangle setup information of the second primitive.

In some embodiments, the update determination unit may compare an area of the second primitive with a threshold area, compare an X-axis length of the second primitive with a threshold X-axis length, and compare a Y-axis length of the second primitive with a threshold Y-axis length.

In some embodiments, in order to store the information regarding the second primitive in the visibility buffer based on the result of determining whether the position information of the second primitive is to be stored in the visibility buffer, the update unit may store the information regarding the second primitive in the visibility buffer based on at least one of whether a screen space is divided into a plurality of regions, an inclusive relationship between the second primitive and the plurality of regions of the screen space, and a hierarchical relationship between the plurality of regions of the screen space.

According to another aspect of the present inventive concepts, a system-on-chip (SoC) includes a memory interface configured to exchange data with a memory including a visibility buffer configured to store position information and triangle correlation information of each of first primitives determined to be visible primitives; a GPU configured to process data received from the memory interface and output the processed data; and a display controller configured to transmit the processed data to a display. The GPU includes a primitive assembler configured to produce position information of the first primitive and position information of a second primitive; and a visibility tester configured to perform a visibility test based on triangle correlation information of the first primitive and the position information of the second primitive, and, prior to operating a rasterizer, remove the second primitive based on a result of the visibility test.

In some embodiments, the position information of the first primitive comprises X, Y, and Z coordinates of each vertex of the first primitive, and the position information of the second primitive comprises X, Y, and Z coordinates of each vertex of the second primitive.

In some embodiments, the visibility tester determines whether the second primitive is included in the first primitive based on the position information of the second primitive and the position information and the triangle correlation information of the first primitive, and, when it is determined that the second primitive is included in the first primitive, compares the Z coordinates of the vertices of the first primitive with the Z coordinates of the vertices of the second primitive.

In some embodiments, the SoC includes an update determination unit configured to determine whether the position information of the second primitive is to be stored in the visibility buffer based on the result of the visibility test; and an update unit configured to store information regarding the second primitive in the visibility buffer based on a result of determining whether the position information of the second primitive is to be stored in the visibility buffer.

In some embodiments, the SoC includes a triangle setup unit configured to produce triangle correlation information of the second primitive from the position information of the second primitive and transmit the triangle correlation information to the visibility buffer or the update unit based on the result of determining whether the position information of the second primitive is to be stored in the visibility buffer.

In some embodiments, the SoC includes an initial triangle setup unit configured to produce triangle correlation information of the second primitive from the position information of the second primitive based on the result of determining whether the position information of the second primitive is to be stored in the visibility buffer.

In some embodiments, the SoC includes a triangle setup unit configured to receive the triangle correlation information of the second primitive and produce triangle setup information of the second primitive.

According to another aspect of the present inventive concepts, a data processing system includes a memory including a visibility buffer configured to store position information and triangle correlation information of each of first primitives determined to be visible primitives; a data processing device configured to process data received from the memory and output the processed data; and a display controller configured to receive the processed data and display images corresponding to the processed data. The data processing device includes a primitive assembler configured to produce position information of the first primitive and position information of a second primitive; and a visibility tester configured to perform a visibility test based on triangle correlation information of the first primitive and the position information of the second primitive, and, prior to operating a rasterizer, remove the second primitive based on a result of the visibility test before a rasterizer is operated.

According to another aspect of the present inventive concepts, a data processing system includes a memory comprising a visibility buffer, the visibility buffer storing position information and triangle correlation information of each of first primitives determined as visible primitives; a graphic processing unit processing data received from the memory interface and outputting the processed data; a primitive assembler producing position information of the first primitive and position information of a second primitive; a rasterizer transforming a plurality of primitives into a plurality of pixels; and a visibility tester performing a visibility test based on triangle correlation information of the first primitive and the position information of the second primitive, and, prior to operating a rasterizer, removing the second primitive based on a result of the visibility test.

In some embodiments, the position information of the first primitive comprises X, Y, and Z coordinates of each vertex of the first primitive, and the position information of the second primitive comprises X, Y, and Z coordinates of each vertex of the second primitive.

In some embodiments, the visibility tester determines whether the second primitive is included in the first primitive based on the position information of the second primitive and the position information and the triangle correlation information of the first primitive, and, when it is determined that the second primitive is included in the first primitive, compares the Z coordinates of the vertices of the first primitive with the Z coordinates of the vertices of the second primitive.

In some embodiments, the data processing system further includes an update determination unit determining whether the position information of the second primitive is to be stored in the visibility buffer based on the result of the visibility test; and an update unit storing information regarding the second primitive in the visibility buffer based on a result of determining whether the position information of the second primitive is to be stored in the visibility buffer.

In some embodiments, the data processing system further includes a triangle setup unit producing triangle correlation information of the second primitive from the position information of the second primitive and transmitting the triangle correlation information to the visibility buffer or the update unit based on the result of determining whether the position information of the second primitive is to be stored in the visibility buffer.

### BRIEF DESCRIPTION OF THE DRAWINGS

The foregoing and other features and advantages of the inventive concepts will be apparent from the more particular description of embodiments of the inventive concepts, as illustrated in the accompanying drawings in which like reference characters refer to the same parts throughout the different views. The drawings are not necessarily to scale, emphasis instead being placed upon illustrating the principles of the inventive concepts.

FIG. 1 is a block diagram of a data processing system including a graphic processing unit (GPU) according to an example embodiment of the present inventive concepts.

FIG. 2 is a schematic block diagram of a memory of FIG. 1 according to an example embodiment of the present inventive concepts.

FIG. 3 is a schematic block diagram of the GPU of FIG. 1 according to an example embodiment of the present inventive concepts.

FIG. 4 is a block diagram of a primitive culling unit of FIG. 3 according to an example embodiment of the present inventive concepts.

FIG. 5 is a block diagram of a primitive culling unit of FIG. 3 according to an example embodiment of the present inventive concepts.

FIG. 6 is a diagram illustrating an operation of a visibility tester illustrated in FIGS. 4 and 5 according to an example embodiment of the present inventive concepts.

FIG. 7 is a diagram illustrating an operation of an update determination unit of FIGS. 4 and 5 according to an example embodiment of the present inventive concepts.

FIG. 8 is a diagram illustrating an operation of an update unit of FIGS. 4 and 5 according to an example embodiment of the inventive concepts.

FIG. 9 is a diagram illustrating an operation of the update unit of FIGS. 4 and 5 according to an example embodiment of the inventive concepts.

FIG. 10 is a flowchart of a method of operating a GPU according to an example embodiment of the present inventive concepts.

FIG. 11 is a flowchart of a method of operating a GPU according to an example embodiment of the present inventive concepts.

FIG. 12 is a flowchart of a method of operating a GPU according to an example embodiment of the present inventive concepts.

FIG. 13 is a detailed flowchart of an operation of performing a visibility test of FIG. 10 to FIG. 12 according to an example embodiment of the present inventive concepts.

FIG. 14 is a detailed flowchart of an operation of determining whether position information of a second primitive is to be stored in a visibility buffer of FIGS. 11 and 12 according to an example embodiment of the present inventive concepts.

### DETAILED DESCRIPTION OF THE EMBODIMENTS

The various example embodiments will be described more fully hereinafter with reference to the accompanying drawings, in which some example embodiments of the present inventive concepts are shown. The present inventive concepts may, however, be embodied in many different forms and should not be construed as limited to the example embodiments set forth herein.

It will be understood that when an element is referred to as being “on,” “connected to” or “coupled to” another element or layer, it can be directly on, connected or coupled to the other element or layer or intervening elements or layers may be present. In contrast, when an element or layer is referred to as being “directly on,” “directly connected to” or “directly coupled to” to another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. Thus, a first element, component, region, layer or section discussed below could be termed a second element, component, region, layer or section without departing from the teachings of the present inventive concept.

The terminology used herein is for the purpose of describing particular example embodiments only and is not intended to be limiting of the present inventive concepts. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Example embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concepts.

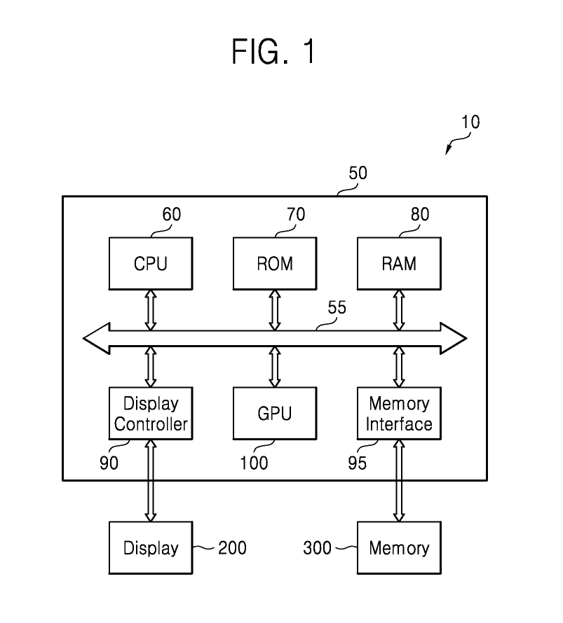

FIG. 1 is a block diagram of a data processing system 10 including a graphic processing unit (GPU) 100 according to an example embodiment of the present inventive concepts.

Referring to FIG. 1, the data processing system 10 may include a data processing device 50, a display 200, and a memory 300.

The data processing system 10 may comprise a personal computer (PC), a portable electronic device (or a mobile device), an electronic device, or the like, including the display 300 capable of displaying image data.

The portable electronic device, that is, the data processing system 10, may comprise a laptop computer, a mobile phone, a smartphone, a tablet personal computer (PC), a mobile interne device (MID), a personal digital assistant (PDA), an enterprise digital assistant (EDA), a digital still camera, a digital video camera, a portable multimedia player (PMP), a personal/portable navigation device (PND), a handheld game console, an e-book, or the like.

The data processing device 50 may control the display 200 and/or the memory 300. That is, the data processing device 50 may control overall operations of the data processing system 10.

The data processing device 50 may comprise a printed circuit board (PCB) such as a motherboard, an integrated circuit (IC), a system-on-chip (SoC), or the like. For example, the data processing device 50 may be an application processor.

The data processing device 50 may include a central processing unit (CPU) 60, a read only memory (ROM) 70, a random access memory (RAM) 80, a display controller 90, a memory interface 95, the GPU 100 and a bus 55.

The CPU 60 may control overall operations of the data processing device 50. For example, the CPU 60 may control operations of the various elements, namely, the ROM 70, the RAM 80, the display controller 90, the memory interface 95, and the GPU 100. That is, the CPU 60 may communicate with the various elements, namely, the ROM 70, the RAM 80, the display controller 90, the memory interface 95, and the GPU 100 via a bus 55.

The CPU 60 is capable of reading and executing program instructions.

For example, programs and/or data stored in the memory, that is the ROM 70, the RAM 80, or the memory 300 may be loaded to a memory included in the CPU 60, for example, a cache memory (not shown), under control of the CPU 60.

In some embodiments, the CPU 60 may comprise a multi-core. The multi-core is a single computing component including two or more independent cores.

The ROM 70 may permanently store programs and/or data.

In some embodiments, the ROM 70 may comprise an erasable programmable read-only memory (EPROM) or an electrically erasable programmable ROM (EEPROM).

The RAM 80 may temporarily store programs, data, and/or instructions. For example, the programs and/or data stored in the ROM 70 may be temporarily stored in the RAM 80 under control of the CPU 60 or the GPU 100 or a booting code stored in the ROM 70.

In some embodiments, the RAM 80 may be embodied as a dynamic RAM (DRAM) or a static RAM (SRAM).

The GPU 100 may perform an operation related to graphic processing so as to reduce a load on the CPU 60.

The display controller 90 may control an operation of the display 200.

For example, the display controller 90 may transmit image data, for example, still image data, moving image data, three-dimensional (3D) image data, or stereoscopic 3D image data, output from the memory 300 to the display 200.

The memory interface 95 may function as a memory controller by accessing the memory 300. For example, the data processing device 50 and the memory 300 may communicate with each other via the memory interface 95. That is, the data processing device 50 and the memory 300 may exchange data with each other using the memory interface 95.

The display 200 may display an image corresponding to the image data output from the display controller 90.

For example, the display 200 may comprise a touch screen, a liquid crystal display (LCD), a thin-film transistor-liquid crystal display (TFT-LCD), a light emitting diode (LED) display, an organic LED (OLED) display, an active matrix OLED (AMOLED) display, a flexible display or the like.

The memory 300 may store programs and/or data (or image data) to be processed by the CPU 60 and/or the GPU 100.

The memory 300 may comprise a volatile memory device or a non-volatile memory device.

If the memory 300 comprises a volatile memory device, the volatile memory device may comprise a DRAM, an SRAM, a thyristor RAM (T-RAM), a zero capacitor RAM (Z-RAM), a twin transistor RAM (TTRAM), or the like.

If the memory 300 comprises a non-volatile memory device, the non-volatile memory device may comprise an EEPROM, a flash memory, a magnetic RAM (MRAM), a spin-transfer torque (STT)-MRAM, a conductive bridging RAM (CBRAM), a ferroelectric RAM (FeRAM), a phase-change RAM (PRAM), a resistive RAM (RRAM), a nanotube RRAM, a polymer RAM (PoRAM), a nano floating gate memory (nFGm), a holographic memory, a molecular electronics memory device, an insulator resistance change memory or the like.

Also, if the memory 300 is a non-volatile memory device, the non-volatile memory device may comprise a flash-based memory device, for example, a secure digital (SD) card, a multimedia card (MMC), an embedded-MMC (eMMC), a universal serial bus (USB) flash drive, a universal flash storage (UFS), or the like.

Also, if the memory 300 is a non-volatile memory device, the non-volatile memory device may comprise a hard disk drive (HDD) or a solid-state drive (SSD).

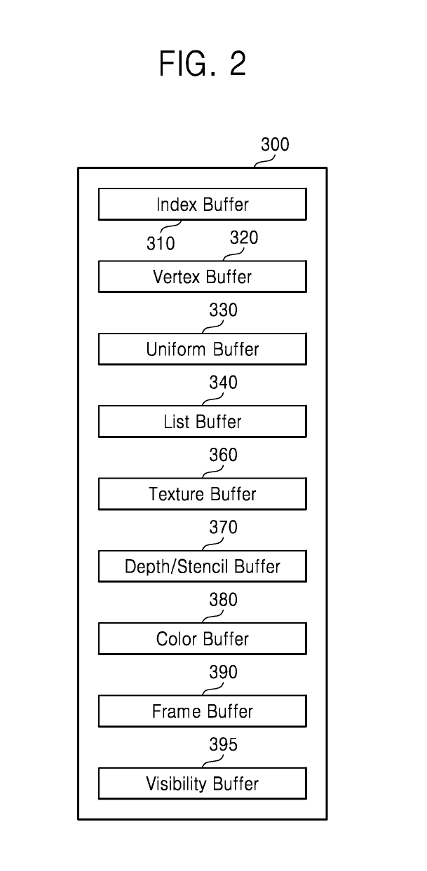

FIG. 2 is a schematic block diagram of the memory 300 of FIG. 1 according to an example embodiment of the present inventive concepts.

Referring to FIGS. 1 and 2, the memory 300 may include an index buffer 310, a vertex buffer 320, a uniform buffer 330, a list buffer 340, a texture buffer 360, a depth/stencil buffer 370, a color buffer 380, a frame buffer 390, and a visibility buffer 395.

The index buffer 310 may store indexes of data stored in the buffers, that is, the vertex buffer 320, the uniform buffer 330, the list buffer 340, the texture buffer 360, the depth/stencil buffer 370, the color buffer 380, the frame buffer 390, and the visibility buffer 395. For example, the indexes may include attribute information, for example, the names, sizes, or the like, of the data, information of the locations at which the data is stored, for example, location information of the vertex buffer 320, the uniform buffer 330, the list buffer 340, the texture buffer 360, the depth/stencil buffer 370, the color buffer 380, the frame buffer 390, and the visibility buffer 395, and the like.

The vertex buffer 320 may store vertex data regarding the attributes, for example, the positions, color, normal vector, and texture coordinates, of a vertex.

The vertex buffer 320 may store vertex data regarding the attributes, for example, the positions, color, normal vector, and texture coordinates, of a tessellated vertex generated by performing a tessellation operation by the GPU 100.

The vertex buffer 320 may also store patch data, or control point data, regarding the attributes, for example, the position, a normal vector, or the like, of each of the control points included in a patch for performing the tessellation operation by the GPU 100.

In some embodiments, the vertex data may contain data regarding the attributes, for example, the position, color, normal vector, and texture coordinates, of each of the vertices of a primitive. For example, the primitive may be understood as vertices, lines, and a polygon.

In some embodiments, the vertex data may contain patch data, or control point data, regarding the attributes, for example, the position, a normal vector, or the like, of each of the control points included in a patch. For example, the patch may be defined with the control points and a parametric equation thereof.

The uniform buffer 330 may store a constant included in a parametric equation that defines a patch, for example, a curve or a surface, and/or a constant for a shading program.

The list buffer 340 may store a list in which each tile obtained by the GPU 100 performing a tiling operation and the indexes of data included in each of the tiles, for example, vertex data, patch data, or tessellated vertex data, are matched.

The texture buffer 360 may store a plurality of texels in the form of tiles.

The depth/stencil buffer 370 may store depth data regarding the depths of pixels included in an image processed by the GPU 100, for example, an image rendered by the GPU 100, and stencil data regarding the stencils of the pixels.

The color buffer 380 may store color data, for example, regarding colors for a blending operation to be performed by the GPU 100.

The frame buffer 390 may store pixel data, or image data, regarding a pixel that is finally processed by the GPU 100.

The visibility buffer 395 may store position information and triangle correlation information of each of the primitives determined as visible primitives, that is, occluders.

The position information may be the 3D space coordinates (X, Y, and Z coordinates) of each vertex of each of the primitives. The triangle correlation information may be vectors of the sides of a triangle formed by the vertices.

The triangle correlation information is not limited by a specific mathematical formula, and is a generic term for various types of information defining the correlation between the primitives, except for the position information.

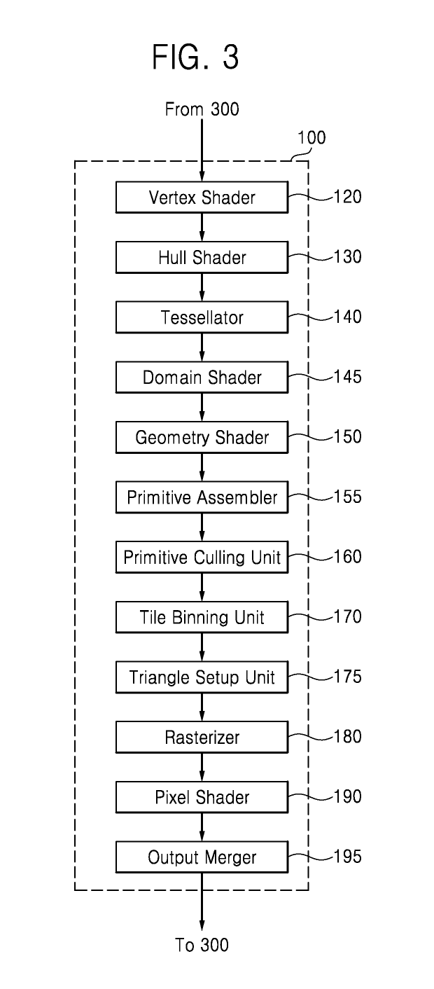

FIG. 3 is a schematic block diagram of the GPU 100 of FIG. 1 according to an example embodiment of the present inventive concepts.

Referring to FIGS. 1 to 3, the GPU 100 receives data output from the memory 300 by using the CPU 60 and/or the memory interface 95 or transmits data processed by the GPU 100 to the memory 300, but descriptions of the CPU 60 and the memory interface 95 are omitted herein for convenience of explanation.

The GPU 100 may include a vertex shader 120, a hull shader 130, a tessellator 140, a domain shader 145, a geometry shader 150, a primitive assembler 155, a primitive culling unit 160, a tile binning unit 170, a triangle setup unit 175, a rasterizer 180, a pixel shader 190, and an output merger 195.

The functions and operations of the various elements, that is, the vertex shader 120, the hull shader 130, the tessellator 140, the domain shader 145, the geometry shader 150, the primitive assembler 155, the tile binning unit 170, the triangle setup unit 175, the rasterizer 180, the pixel shader 190, and the output merger 195 of the GPU 100, not including the primitive culling unit 160, according to an example embodiment of the present inventive concepts may be substantially the same as those of the stages included in the graphics pipeline of Microsoft's Direct3D™ 11 and having the same names as these elements.

The vertex shader 120 may receive and process vertex data output from the vertex buffer 320. For example, the vertex shader 120 may process the vertex data, for example, through transformation, morphing, skinning, lighting or the like.

The hull shader 130 may receive the processed vertex data output from the vertex shader 120, and determine a tessellation factor for a patch corresponding to the received processed vertex data.

For example, the tessellation factor determined by the hull shader 130 may be understood as a level of detail to which the patch corresponding to the received processed vertex data is finely expressed.

The hull shader 130 may output vertices, or control points, included in the received processed vertex data, a parametric equation, and the tessellation factor to the tessellator 140.

The tessellator 140 may receive the vertices, or control points, included in the received processed vertex data, the parametric equation, and the tessellation factor from the hull shader 130 and tessellate tessellation domain coordinates based on the tessellation factor determined by the hull shader 130. For example, the tessellation domain coordinates may be defined by coordinates (u, v) or (u, v, w),

The tessellator 140 may output the tessellated domain coordinates to the domain shader 145.

The domain shader 145 may receive the tessellated domain coordinates from the tessellator 140 and produce tessellated vertices by calculating the space coordinates of the patch corresponding to the tessellated domain coordinates based on the tessellation factor and the parametric equation. For example, the space coordinates may be defined by coordinates (x, y, z). Also, vertex data regarding the tessellated vertices may be tessellated vertex data, and may be stored in the vertex buffer 320 and output to the geometry shader 150.

The geometry shader 150 may produce new tessellated vertices by adding adjacent vertices to or removing the adjacent vertices from the tessellated vertices output from the domain shader 145.

The primitive assembler 155 may produce primitives, that is, points, lines, and triangles, based on the new tessellated vertices output from the geometry shader 150. Information regarding the primitives produced by the primitive assembler 155 may include position information, for example, 3D space coordinates which is information regarding the position attributes of the primitives. For example, the space coordinates may be defined by coordinates (x, y, z).

The primitive assembler 155 may output primitive data including the position information of each of the primitives to the primitive culling unit 160.

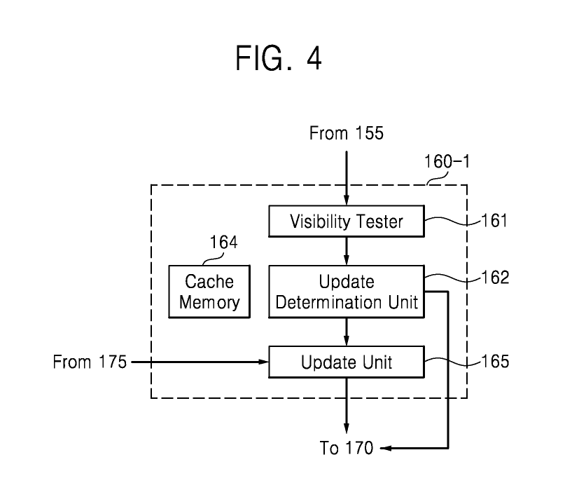

The primitive culling unit 160 may receive the primitive data output from the primitive assembler 155 and remove invisible primitives based on the position information of each of the primitives and the position information and the triangle correlation information of the occluders stored in the visibility buffer 395. Also, the primitive culling unit 160 may determine whether primitives determined as visible primitives are to be updated in the visibility buffer 395 based on the position information of each of the primitives and the position information and the triangle correlation information of the occluders. An operation of the primitive culling unit 160 will be described in detail with reference to FIGS. 4 to 9.

The primitive culling unit 160 may output primitive data regarding primitives, without outputting primitive data for the invisible primitives, to the tile binning unit 170.

The location of the primitive culling unit 160 illustrated in FIG. 3 is merely an example and is not limited thereto.

The tile binning unit 170 may tile the primitive data output from the primitive culling unit 160 and output the tiled primitive data to the triangle setup unit 175.

For example, the tile binning unit 170 may project a primitive corresponding to each piece of the primitive data onto a virtual space corresponding to the display 200, that is, a screen space, bin the screen space into tiles based on a bounding box assigned to each of the primitives, and make a list in which each of the tiles is matched with an index of a primitive included in each of the tiles. The tile binning unit 170 may store the list in the list buffer 340.

In some embodiments, the tile binning unit 170 may be omitted.

The triangle setup unit 175 may calculate information, that is, triangle setup information, such as triangle correlation information and/or increments based on the tiled primitive data. The calculated information is needed to operate the rasterizer 180 or the pixel shader 190. The triangle setup unit 175 may output processed primitive data including the various types of information described above to the rasterizer 180.

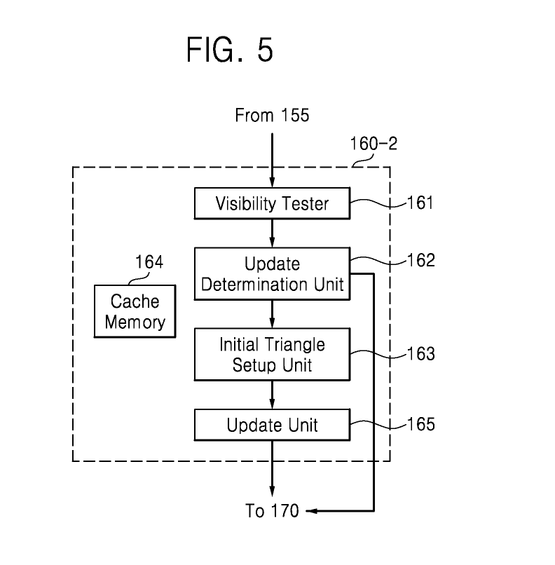

In some embodiments, when, as illustrated in FIG. 4, the primitive culling unit 160 does not include an initial triangle setup unit 163 as illustrated in FIG. 5, the triangle setup unit 175 may produce triangle setup information of each occluder and store triangle correlation information included in the triangle setup information in the visibility buffer 395. The triangle setup unit 175 operates under control of the update unit 165 of FIG. 4. In some embodiments, the triangle setup unit 175 may transmit the triangle setup information of each of the occluders to the update unit 165 of FIG. 4. In some embodiments, when the primitive culling unit 160 includes the initial triangle setup unit 163, as illustrated in FIG. 5, the triangle setup unit 175 may bypass calculating the triangle correlation information of each of the occluders, which is produced by the initial triangle setup unit 163. However, although the triangle setup unit 175 does not calculate the triangle correlation information of each of the occluders, the triangle setup unit 175 may produce the triangle correlation information of each of the occluders by producing information such as increments.

The rasterizer 180 may transform a plurality of primitives into a plurality of pixels based on the processed primitive data output from the triangle setup unit 175.

The pixel shader 190 may receive the output from the rasterizer 180 and handle an effect of the plurality of pixels output from the rasterizer 180. For example, the effect of the plurality of pixels may be the colors of the plurality of pixels or a contrast between the plurality of pixels.

In some embodiments, the pixel shader 190 may perform computation operations to handle the effect. The computation operations may include texture mapping, color format conversion, or the like.

The texture mapping performed by the pixel shader 190 may be an operation of mapping a plurality of texels output from the texture buffer 360 so as to add details to the plurality of pixels output from the rasterizer 180.

The color format conversion performed by the pixel shader 190 may be an operation of converting the format of the plurality of pixels output from the rasterizer 180 into an RGB format, a YUV format, a YCoCg format, or the like.

The output merger 195 may determine final pixels to be displayed on the display 200 of FIG. 1 among a plurality of pixels processed using information regarding previous pixels, and produce colors of the determined final pixels. For example, the information regarding the previous pixels may be depth information, stencil information, color information, or the like.

For example, in some embodiments, the output merger 195 may perform a depth test on the processed plurality of pixels based on depth data output from the depth/stencil buffer 370, and determine the final pixels based on a result of performing the depth test.

In some embodiments, the output merger 195 may perform a stencil test on the processed plurality of pixels based on stencil data output from the depth/stencil buffer 370, and determine the final pixels based on a result of performing the stencil test.

In some embodiments the output merger 195 may blend the determined final pixels, based on color data output from the color buffer 380.

The output merger 195 may output pixel data, or image data, regarding the determined final pixels to the frame buffer 390.

The pixel data output by the output merger 195 may be stored in the frame buffer 390 and displayed on the display 200 using the display controller 90.

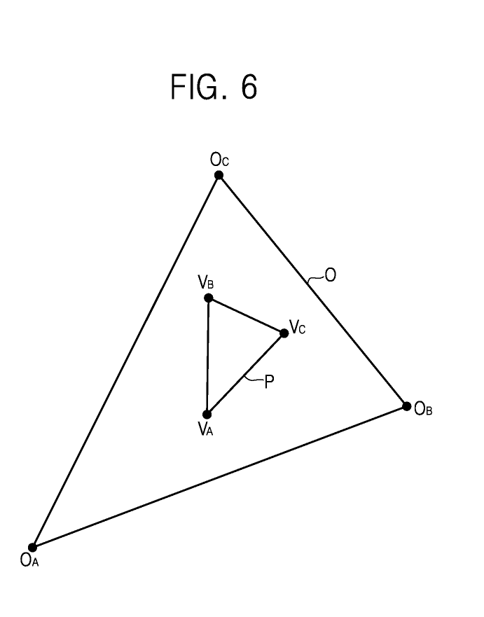

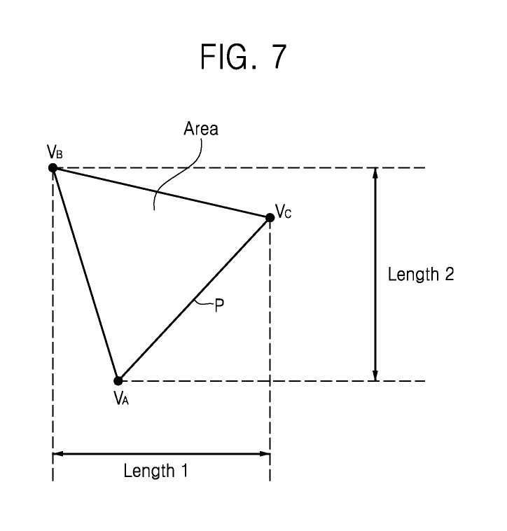

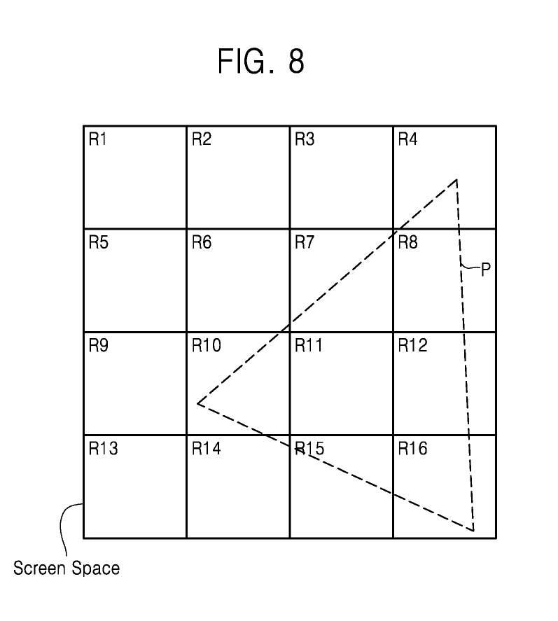

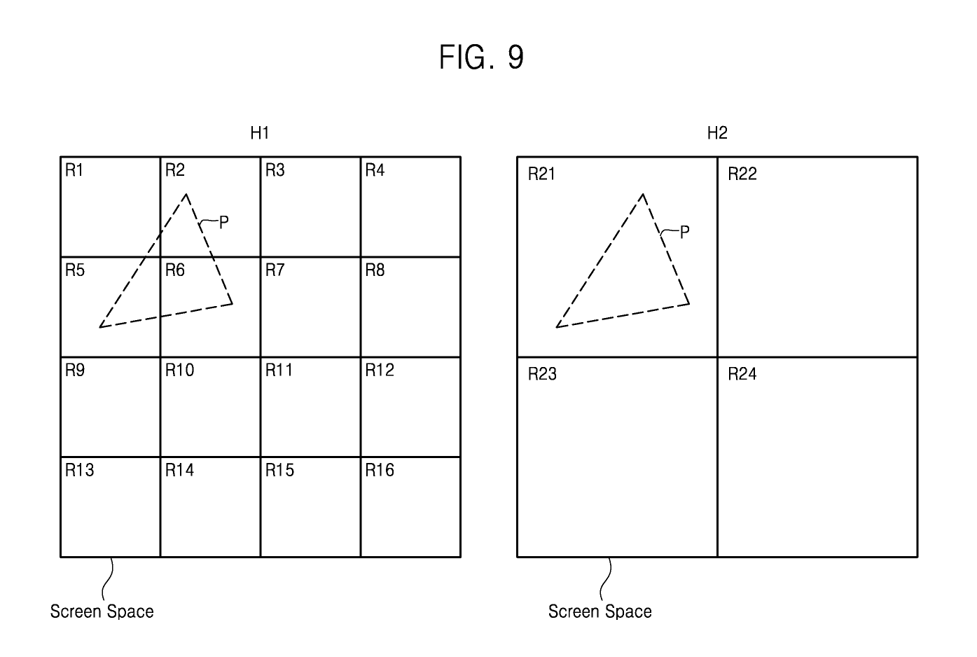

FIG. 4 is a block diagram of a primitive culling unit 160-1 that is an example embodiment of the primitive culling unit 160 of FIG. 3 according to an example embodiment of the present inventive concepts. FIG. 5 is a block diagram of a primitive culling unit 160-2 that is an example embodiment of the primitive culling unit 160 of FIG. 3 according to an example embodiment of the present inventive concepts. FIG. 6 is a diagram illustrating an operation of a visibility tester 161 illustrated in FIGS. 4 and 5 according to an example embodiment of the present inventive concepts. FIG. 7 is a diagram illustrating an operation of an update determination unit 162 of FIGS. 4 and 5 according to an example embodiment of the present inventive concepts. FIG. 8 is a diagram illustrating an operation of an update unit 165 of FIGS. 4 and 5 according to an example embodiment of the present inventive concepts. FIG. 9 is a diagram illustrating an operation of the update unit 165 of FIGS. 4 and 5 according to an example embodiment of the present inventive concepts.

Referring to FIGS. 1 to 9, the primitive culling unit 160-1 of FIG. 4 may include the visibility tester 161, the update determination unit 162, a cache memory 164, and the update unit 165.

The visibility tester 161 may receive primitive data from the primitive assembler 155. The visibility tester 161 may perform a visibility test based on position information of a primitive corresponding to the primitive data and position information and triangle correlation information of an occluder uploaded to the cache memory 164.

For convenience of explanation, a primitive corresponding to primitive data that is currently input to the visibility tester 161 will be defined as a second primitive, and an occluder used to perform the visibility test on the second primitive will be defined as a first primitive.

The visibility test performed by the visibility tester 161 may be largely divided into a search process, an inclusion determination process, and a depth comparison process.

In the search process of the visibility test, the visibility tester 161 may search the visibility buffer 395 of the memory 300 for first primitives related to the second primitive in terms of location, and upload position information and triangle correlation information of the first primitives to the cache memory 164. For example, since position information of the second primitive includes X and Y coordinates of respective vertices of the second primitive, the position information and the triangle correlation information of the respective first primitives, the two-dimensional (2D) positions of which may overlap the 2D position of the second primitive, may be uploaded to the cache memory 164. The search process may be more effectively performed using a method of updating the visibility buffer 395 which will be described hereinafter.

In the inclusion determination process of the visibility test, the visibility tester 161 may determine whether the second primitive is included in the first primitives based on the position information of the second primitive and the position information and triangle correlation information of the first primitives.

In FIG. 6, a first primitive O includes three vertices O_{A}, O_{B}, and O_{C}, and a second primitive P includes three vertices V_{A}, V_{B}, and V_{C}. ‘(first vertex-second vertex)’ may be defined as a vector connecting between the second vertex and the first vertex, (first vector×second vector) may be defined as an outer product of the first vector and the second vector, and (first vector second vector) may be defined as an inner product of the first vector and the second vector. Also, ‘n’ may be defined as a normal vector.

When the three vertices O_{A}, O_{B}, and O_{C} of the first primitive O and the three vertices V_{A}, V_{B}, and V_{C} of the second primitive P satisfy Equations 1 to 3 below, the visibility tester 161 may determine that the second primitive P is included in the first primitive O. When the three vertices O_{A}, O_{B}, and O_{C} of the first primitive O and the three vertices V_{A}, V_{B}, and V_{C} of the second primitive P do not satisfy any one of Equations 1 to 3 below, the visibility tester 161 may determine that the second primitive P is not included in the first primitive O.

(O_{B}−O_{A})×(V_{A}−O_{A})·n≧0 [Equation 1]

(O_{C}−O_{B})×(V_{B}−O_{B})·n≧0 [Equation 2]

(O_{A}−O_{C})×(V_{C}−O_{C})·n≧0 [Equation 3]

‘(O_{B}−O_{A})’ in Equation 1, ‘(O_{C}−O_{B})’ in Equation 2, and ‘(O_{A}−O_{C})’ in Equation 3 may correspond to the triangle correlation information of the first primitive O. ‘(V_{A}−O_{A})’ in Equation 1, ‘(V_{B}−O_{B})’ in Equation 2, and ‘(V_{C}−O_{C})’ in Equation 3 may be calculated from the position information of the first primitive O and the position information of the second primitive P.

In the depth comparison process of the visibility test, the visibility tester 161 may compare the Z coordinates of the respective vertices of the first primitive O with the Z coordinates of the respective vertices of the second primitive P when the second primitive is included in the first primitive O.

For example, referring to FIG. 6, when the second primitive P is included in the first primitive O, the visibility tester 161 may compare the Z coordinates of the respective three vertices O_{A}, O_{B}, O_{C} of the first primitive O with the Z coordinates of the respective three vertices V_{A}, V_{B}, and V_{C} of the second primitive P to determine whether the second primitive P is hidden by the first primitive O. If it is assumed that the smaller the value of the Z coordinates, the shorter the distance from a user, when a smallest one of the Z coordinates of the three vertices V_{A}, V_{B}, and V_{C} of the second primitive P are greater than a greatest one of the Z coordinates of the three vertices O_{A}, O_{B}, and O_{C} of the first primitive O, the second primitive P may be determined to be hidden by the first primitive O. That is, if the smallest one of the Z coordinates of the three vertices V_{A}, V_{B}, and V_{C} of the second primitive P are greater than a greatest one of the Z coordinates of the three vertices O_{A}, O_{B}, and O_{C} of the first primitive O, the first primitive O is a shorter distance from the user and hides the second primitive P.

The search process, the inclusion determination process, and the depth comparison process may be sequentially performed. However, in some embodiments, the search process, the inclusion determination process, and the depth comparison process may be performed in parallel.

When it is determined that the second primitive P is hidden by the first primitive O, that is, when the second primitive P is an invisible primitive, the visibility tester 161 may remove the second primitive P from the series of graphics pipelines illustrated in FIG. 3. When it is determined that the second primitive P is not hidden by the first primitive O, that is, when the second primitive P is a visible primitive, the visibility tester 161 may output information regarding the second primitive P to the update determination unit 162.

The update determination unit 162 may determine whether the position information of the second primitive P is to be stored in the visibility buffer 395 based on a result of performing the visibility test. That is, the update determination unit 162 determines whether the second primitive P is to be used as an occluder based on the result of performing the visibility test. When the second primitive P is stored in the visibility buffer 395, the stored second primitive P may be used as a first primitive (occluder) of another second primitive that is input in a subsequent process.

In FIG. 7, the update determination unit 162 may calculate the area Area, the X-axis length Length1 and the Y-axis length Length2 of a second primitive P based on the X, Y, and Z coordinates of each of three vertices V_{A}, V_{B}, and V_{C} of the second primitive P.

The area Area of the second primitive P may be the inner area of the second primitive P. The X-axis length Length1 of the second primitive P may be the difference between a maximum X coordinate and a minimum X coordinate among the X coordinates of the vertices V_{A}, V_{B}, and V_{C} of the second primitive P. The Y-axis length Length2 of the second primitive P may be the difference between a maximum Y coordinate and a minimum Y coordinate among the Y coordinates of the vertices V_{A}, V_{B}, and V_{C} of the second primitive P.

Also, the update determination unit 162 may compare the calculated area Area of the second primitive P with a threshold area, compare the calculated X-axis length Length1 of the second primitive P with a threshold X-axis length, and compare the calculated Y-axis length Length2 of the second primitive P with a threshold Y-axis length.

If the area Area, the X-axis length Length1, and the Y-axis length Length2 of the second primitive P are greater than the threshold area, the threshold X-axis length, and the threshold Y-axis length, respectively, the update determination unit 162 may store position information of the second primitive P in the visibility buffer 395 and determine the second primitive P to be used as an occluder. That is, in consideration of the capacity of the visibility buffer 395 and the amount of calculation performed by the visibility tester 161,

it is more efficient to use only the second primitive P, the size of which is equal to or greater than a predetermined size, as an occluder.

When the second primitive P is determined to be used as an occluder, the update determination unit 162 may output information regarding the second primitive P to the update unit 165. When the second primitive P is determined not to be used as an occluder, the update determination unit 162 may output the information regarding the second primitive P to the tile binning unit 170.

When it is determined that the received information regarding the second primitive P is to be stored in the visibility buffer 395, the update unit 165 may store the information regarding the second primitive P in the visibility buffer 395. The update unit 165 stores the information regarding the second primitive in the visibility buffer 395 based on at least one of whether a screen space is to be divided into a plurality of regions, an inclusive relationship between the second primitive P and the plurality of regions of the screen space, and a hierarchical relationship between the plurality of regions of the screen space.

When the primitive culling unit 160 does not include the initial triangle setup unit 163 of FIG. 5, as illustrated in FIG. 4, the information regarding the second primitive P is position information of the second primitive P. Then, the update unit 165 may store the position information of the second primitive P in the visibility buffer 395, and control the triangle setup unit 175, as illustrated in FIG. 3, to store triangle correlation information of the second primitive P, which is produced by the triangle setup unit 175, to be stored in the visibility buffer 395. As described above, in a method of controlling the triangle setup unit 175 using the update unit 165, information indicating that the second primitive P is an occluder may be included in the second primitive P deter mined as an occluder. However, the example embodiments of the present inventive concepts are not limited thereto. In some embodiments, the update unit 165 may receive the triangle correlation information of the second primitive P, which is produced by the triangle setup unit 175, from the triangle setup unit 175 in a path indicated by an arrow in FIG. 4, and store the triangle correlation information together with the position information of the second primitive P in the visibility buffer 395.

When the primitive culling unit 160 includes the initial triangle setup unit 163 as illustrated in FIG. 5, the information regarding the second primitive P is the position information and the triangle correlation information of the second primitive P. The update unit 165 may store the position information and the triangle correlation information of the second primitive P in the visibility buffer 395.

When the information regarding the second primitive P is stored in the visibility buffer 395, the update unit 165 may consider the visibility buffer 395 as one region and store the information regarding the second primitive P in the visibility buffer 395 without dividing the screen space into a plurality of regions.

Referring to FIG. 8, in order to store the information regarding the second primitive P in the visibility buffer 395, the update unit 165 may divide the screen space into a plurality of regions, for example, regions R1 to R16, divide the visibility buffer 395 into a plurality of regions, for example, regions corresponding to the regions R1 to R16 of the scree space, and store the information regarding the second primitive P in the plurality of regions of the visibility buffer 395.

For example, when the second primitive P is located on the screen space in a manner as illustrated in FIG. 8, the update unit 165 may store the information regarding the second primitive P in the regions of the visibility buffer 395 corresponding to the regions R4, R6 to R8, R10 to R12, and R14 to R16 of the screen space.

Also, the update unit 165 may store the information regarding the second primitive P according to an inclusive relationship between the second primitive P and the plurality of regions R1 to R16 of the screen space.

For example, the update unit 165 may store the information regarding the second primitive P in only the region of the visibility buffer 395 corresponding to the region R11 of the screen space that entirely overlaps with a region of the second primitive P and may not store the information regarding the second primitive P in the regions of the visibility buffer 395 corresponding to the regions R4, R6 to R8, R10, R12, and R14 to R16 of the screen space that partially overlap with the second primitive P among the plurality of regions R1 to R16 of the screen space. Thus, the efficiency of the visibility buffer 395 with respect to the capacity thereof may increase.

In some embodiments, the update unit 165 may determine whether the information regarding the second primitive P is to be stored in a region of the visibility buffer 395 corresponding to a region that partially overlaps with the second primitive P among the plurality of regions R1 to R16 of the screen space, based on the area of this region.

As illustrated in FIG. 9, the update unit 165 may divide a screen space into a first hierarchy H1 divided into m regions, for example, sixteen regions R1 to R16, and a second hierarchy H2 divided into n regions, for example, four regions R21 to R24. The update unit 165 may further divide the visibility buffer 395 into regions corresponding to the regions of the respective first and second hierarchies H1 and H2 of the screen space, for example, a region R1 of the first hierarchy H1 or a region R21 of the second hierarchy H2, and store the information regarding the second primitive P in the regions of the visibility buffer 395. Here, ‘m’ and ‘n’ each denote an integer that is equal to or greater than ‘1’, and m>n. In some embodiments, the screen space may be divided into more than two hierarchies, and the number of regions ‘m’ and ‘n’ of the example embodiment are not limited thereto.

The update unit 165 may store the information regarding the second primitive P either in the regions of the visibility buffer 395 corresponding to the m regions of the first hierarchy H1 of the screen space at which the second primitive P is located or the regions of the visibility buffer 395 corresponding to the n regions of the second hierarchy H2 of the screen space at which the second primitive P is located.

For example, if the second primitive P is located on the screen space as illustrated in FIG. 9, the update unit 165 may store the information regarding the second primitive P in the regions of the visibility buffer 395 corresponding to the four regions R1, R2, R5, and R6 of the first hierarchy H1 of the screen space, and may store the information regarding the second primitive P in only the region of the visibility buffer 395 corresponding to the region R1 of the second hierarchy H2 of the screen space.

Thus, since the update unit 165 stores the information regarding the second primitive P in the regions of the visibility buffer 395 that are arranged in a hierarchy according to the size and location of the second primitive P on the screen space, the speed of searching for an occluder to be used in the visibility tester 161 and the efficiency of the visibility buffer 395 with respect to the capacity thereof may increase.

The primitive culling unit 160-2 of FIG. 5 may further include the initial triangle setup unit 163, unlike the primitive culling unit 160-1 of FIG. 4.

The initial triangle setup unit 163 may produce the triangle correlation information of the second primitive P from the position information of the second primitive P which has been determined to be used as an occluder by the update determination unit 162. The triangle correlation information of the second primitive P produced by the initial triangle setup unit 163 may be stored in a corresponding region of the visibility buffer 395 by the update unit 165. When the triangle correlation information of the second primitive P is transmitted to the triangle setup unit 175 or stored in the visibility buffer 395, the triangle setup unit 175 may skip performing an operation on the triangle correlation information of the second primitive P which has been determined to be used as an occluder.

Thus, a GPU according to an example embodiment of the present inventive concepts is capable of selectively removing a primitive, based on triangle correlation information of an occluder stored beforehand after the position of the primitive is determined. Thereby, an undesired workload and/or undesired data may be reduced. Accordingly, the whole performance of the GPU 100 may increase and power consumption of the GPU 100 may decrease.

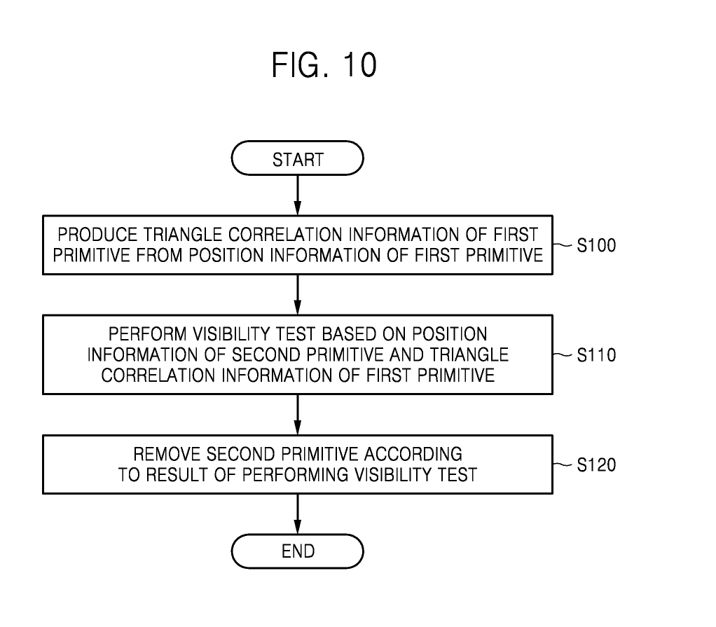

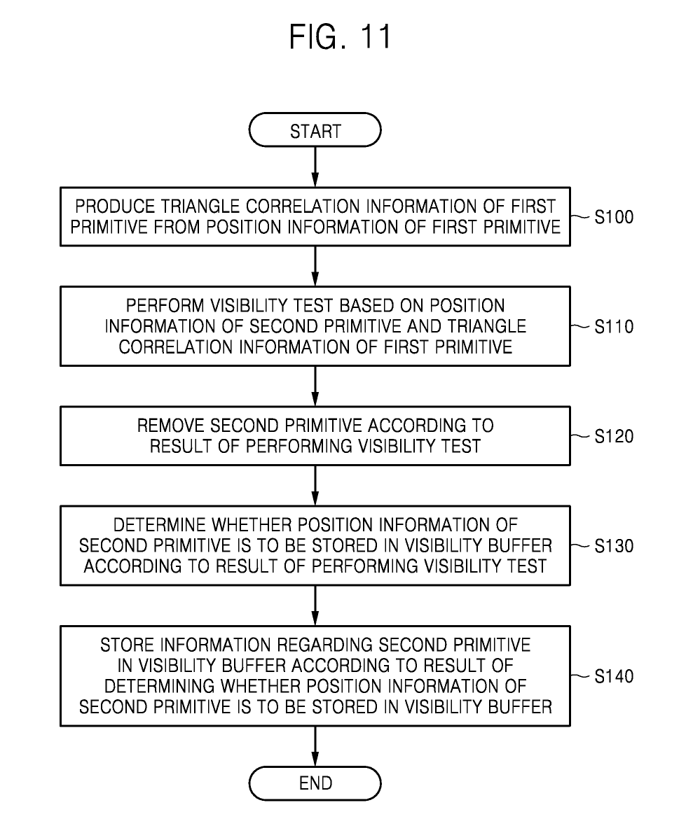

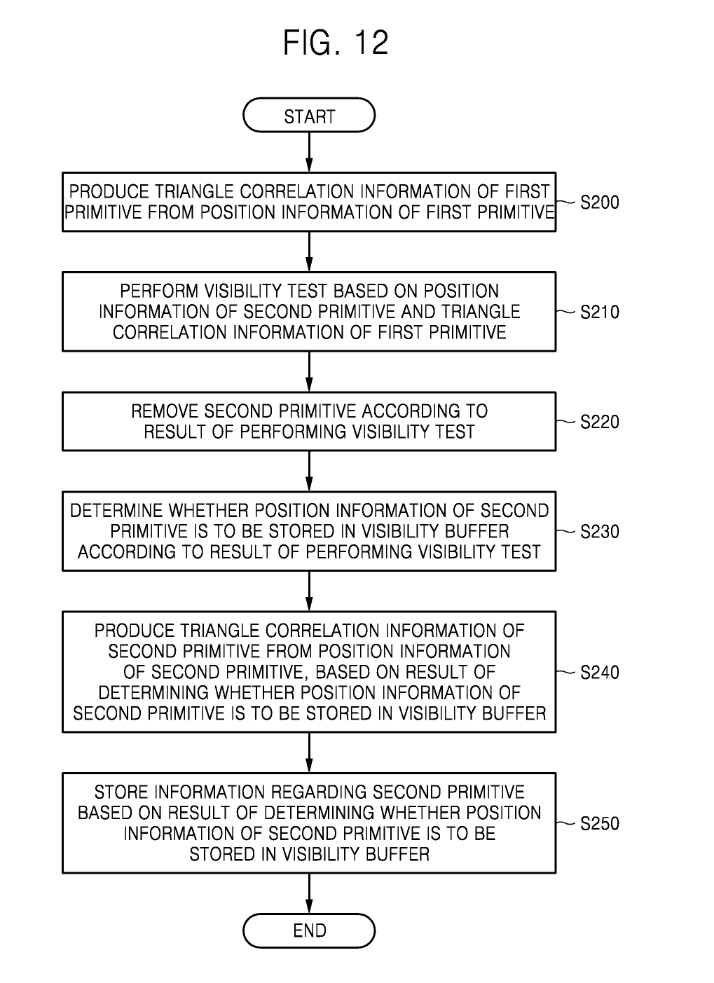

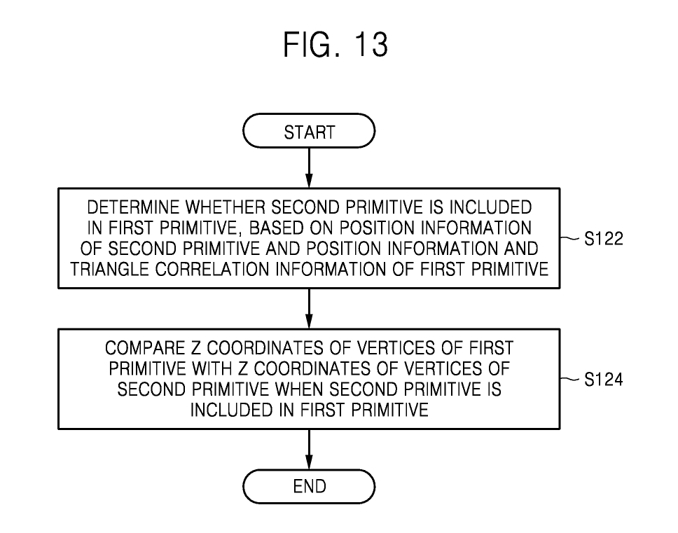

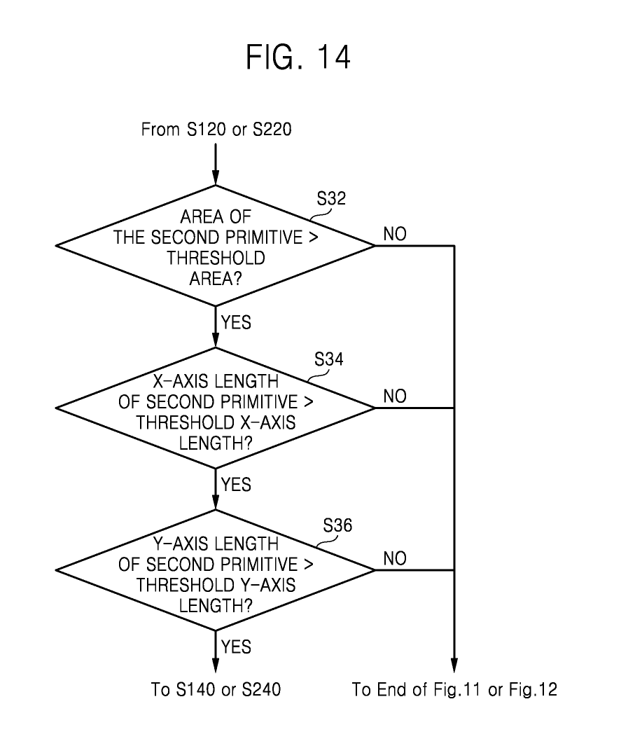

FIG. 10 is a flowchart of a method of operating a GPU according to an example embodiment of the present inventive concepts. FIG. 11 is a flowchart of a method of operating a GPU according to an example embodiment of the present inventive concepts. FIG. 12 is a flowchart of a method of operating a GPU according to an example embodiment of the present inventive concepts. FIG. 13 is a detailed flowchart of an operation of performing a visibility test, for example, operation S110 of FIGS. 10 and 11 and operation S210 of FIG. 12. FIG. 14 is a detailed flowchart of an operation of determining whether position information of a second primitive is to be stored in a visibility buffer, for example, operation 5130 of FIGS. 10 and 11 and operation S230 of FIG. 12.

Referring to FIGS. 1 to 14, the triangle setup unit 175 of FIG. 4 may produce triangle correlation information of a first primitive O which is an occluder from position information of the first primitive O, and store the triangle correlation information in the visibility buffer 395 (operation S100). Alternatively, the initial triangle setup unit 163 of FIG. 5 may produce triangle correlation information of a first primitive O which is an occluder from position information of the first primitive O (operation S100).

The visibility tester 161 may perform a visibility test based on position information of a second primitive P that is currently input and the triangle correlation information of the first primitive O produced by the triangle setup unit 175 of FIG. 4 or the initial triangle setup unit 163 of FIG. 5 (operation S110).

The visibility tester 161 may remove the second primitive P when the second primitive P is determined to be an invisible primitive according to a result of performing the visibility test from the series of graphics pipeline described in connection with FIG. 3 (operation S120).

A method of operating a GPU illustrated in FIG. 11 according to an example embodiment of the present inventive concepts may further include operations S130 and S140 that are performed after operation S100 to S120 of the method of FIG. 10 are performed.

The update determination unit 162 may determine whether the position information of the second primitive P is to be stored in the visibility buffer 395 when the second primitive P is determined to be a visible primitive according to the result of performing the visibility test (operation S130).

Referring to FIG. 14, operation 5130 may include comparing an area of the second primitive P with a threshold area (operation S32), comparing an X-axis length of the second primitive P with a threshold X-axis length (operation S34), and comparing a Y-axis length of the second primitive P with a threshold Y-axis length (operation S36), which are performed by the update determination unit 162.

If the area of the second primitive P is greater than the threshold area, that is, the ‘YES’ branch in operation S32, the X-axis length of the second primitive P is longer than the threshold X-axis length, that is, the ‘YES’ branch in operation S34, and the Y-axis length of the second primitive P is longer than the threshold Y-axis length, that is, the ‘YES’ branch in operation S36, then operation 5140 of FIG. 11 or operation 5240 of FIG. 12 may be performed.

If the area of the second primitive P is less than the threshold area, that is, the ‘NO’ branch in operation S32, the X-axis length of the second primitive P is shorter than the threshold X-axis length, that is, the ‘NO’ branch in operation S34, or the Y-axis length of the second primitive P is shorter than the threshold Y-axis length, that is, the ‘NO’ branch in operation S36, then operation S140 of FIG. 11 or operations S240 and S250 of FIG. 12 may be skipped.

The update unit 165 may store information regarding the second primitive P which is determined to be an occluder in the visibility buffer 395 when it is determined in operation S130, as illustrated in FIG. 14, that the position information of the second primitive P is to be stored in the visibility buffer 395 (operation S140). That is, the update unit 165 may store the information regarding the second primitive P in the visibility buffer 395 based on at least one of whether a screen space is divided into a plurality of regions, an inclusive relationship between the second primitive P and the plurality of regions of the screen space, and a hierarchical relationship between the plurality of regions of the screen space (operation S140).

Operations S200 to S220 included in a method of operating a GPU illustrated in FIG. 12 according to an example embodiment of the present inventive concepts are substantially the same as operations 5100 to S120 of FIGS. 10 and 11. Operations 5230 and 5250 included in a method of operating a GPU illustrated in FIG. 12 according to an example embodiment of the present inventive concepts are substantially the same as operations S130 and S140 of FIG. 11, and are, thus, not redundantly described herein.

The initial triangle setup unit 163 may produce triangle correlation information of a second primitive P which is determined to be an occluder as a result of performing operation S230 from position information of the second primitive P (operation S240). Thus, information regarding the second primitive P stored in operation S250 may further include the triangle correlation information thereof.

Referring to FIG. 13, the visibility tester 161, as in steps S110 and S210 of FIGS. 10, 11 and 12 may determine whether the second primitive P is included in the first primitive O based on the position information of the second primitive P and the position information and the triangle correlation information of the first primitive O (operation S122).

When it is determined in operation S122 that the second primitive P is included in the first primitive O, the visibility tester 161 may compare the Z coordinates of vertices of the first primitive with the Z coordinates of vertices of the second primitive (operation S124).

According to the one or more example embodiments of the present inventive concepts, a GPU, a SoC including the GPU, and a data processing system including the GPU are capable of selectively removing a primitive based on triangle correlation information of an occluder which is stored beforehand after the position of the primitive is determined, thereby reducing the amount of undesired operations and power consumption.

While the present inventive concepts have been particularly shown and described with reference to example embodiments thereof, it will be understood that various changes in form and details may be made therein without departing from the spirit and scope of the following claims.

1. A graphic processing unit comprising:
a primitive assembler configured to produce position information of a first primitive and position information of a second primitive; and
a visibility tester configured to perform a visibility test based on triangle correlation information of the first primitive and the position information of the second primitive, and, prior to operating a rasterizer, remove the second primitive based on a result of the visibility test.

2. The graphic processing unit of claim 1, wherein the position information of the first primitive comprises X, Y, and Z coordinates of each vertex of the first primitive, and
the position information of the second primitive comprises X, Y, and Z coordinates of each vertex of the second primitive.

3. The graphic processing unit of claim 2, wherein the visibility tester determines whether the second primitive is included in the first primitive based on the position information of the second primitive and the position information and the triangle correlation information of the first primitive, and, when it is determined that the second primitive is included in the first primitive, compares the Z coordinates of the vertices of the first primitive with the Z coordinates of the vertices of the second primitive.

4. The graphic processing unit of claim 1, further comprising:
an update determination unit configured to determine whether the position information of the second primitive is to be stored in a visibility buffer based on the result of the visibility test; and
an update unit configured to store information regarding the second primitive in the visibility buffer based on a result of determining whether the position information of the second primitive is to be stored in the visibility buffer.

5. The graphic processing unit of claim 4, further comprising a triangle setup unit configured to produce triangle correlation information of the second primitive from the position information of the second primitive and transmit the triangle correlation information to the visibility buffer or the update unit based on the result of determining whether the position information of the second primitive is to be stored in the visibility buffer.

6. The graphic processing unit of claim 4, further comprising an initial triangle setup unit configured to produce triangle correlation information of the second primitive from the position information of the second primitive based on the result of determining whether the position information of the second primitive is to be stored in the visibility buffer.

7. The graphic processing unit of claim 6, further comprising a triangle setup unit configured to receive the triangle correlation information of the second primitive and produce triangle setup information of the second primitive.

8. The graphic processing unit of claim 4, wherein the update determination unit compares an area of the second primitive with a threshold area, compares an X-axis length of the second primitive with a threshold X-axis length, and compares a Y-axis length of the second primitive with a threshold Y-axis length.

9. The graphic processing unit of claim 4, wherein, in order to store the information regarding the second primitive in the visibility buffer based on the result of determining whether the position information of the second primitive is to be stored in the visibility buffer, the update unit stores the information regarding the second primitive in the visibility buffer based on at least one of whether a screen space is divided into a plurality of regions, an inclusive relationship between the second primitive and the plurality of regions of the screen space, and a hierarchical relationship between the plurality of regions of the screen space.

10.-17. (canceled)

18. A system-on-chip (SoC) comprising:
a memory interface configured to exchange data with a memory including a visibility buffer configured to store position information and triangle correlation information of each of first primitives determined to be visible primitives;
a graphic processing unit configured to process data received from the memory interface and output the processed data; and
a display controller configured to transmit the processed data to a display,
wherein the graphic processing unit comprises:
a primitive assembler configured to produce position information of the first primitive and position information of a second primitive; and
a visibility tester configured to perform a visibility test based on triangle correlation information of the first primitive and the position information of the second primitive, and, prior to operating a rasterizer, remove the second primitive based on a result of the visibility test.

19. The SoC of claim 18, wherein the position information of the first primitive comprises X, Y, and Z coordinates of each vertex of the first primitive, and
the position information of the second primitive comprises X, Y, and Z coordinates of each vertex of the second primitive.

20. The SoC of claim 19, wherein the visibility tester determines whether the second primitive is included in the first primitive based on the position information of the second primitive and the position information and the triangle correlation information of the first primitive, and, when it is determined that the second primitive is included in the first primitive, compares the Z coordinates of the vertices of the first primitive with the Z coordinates of the vertices of the second primitive.

21. The SoC of claim 18, further comprising:
an update determination unit configured to determine whether the position information of the second primitive is to be stored in the visibility buffer based on the result of the visibility test; and
an update unit configured to store information regarding the second primitive in the visibility buffer based on a result of determining whether the position information of the second primitive is to be stored in the visibility buffer.

22. The SoC of claim 21, further comprising a triangle setup unit configured to produce triangle correlation information of the second primitive from the position information of the second primitive and transmit the triangle correlation information to the visibility buffer or the update unit based on the result of determining whether the position information of the second primitive is to be stored in the visibility buffer.

23. The SoC of claim 21, further comprising an initial triangle setup unit configured to produce triangle correlation information of the second primitive from the position information of the second primitive based on the result of determining whether the position information of the second primitive is to be stored in the visibility buffer.

24. The SoC of claim 23, further comprising a triangle setup unit configured to receive the triangle correlation information of the second primitive and produce triangle setup information of the second primitive.

25. (canceled)

26. A data processing system comprising:
a memory comprising a visibility buffer, the visibility buffer storing position information and triangle correlation information of each of first primitives determined as visible primitives;
a graphic processing unit processing data received from the memory interface and outputting the processed data;
a primitive assembler producing position information of the first primitive and position information of a second primitive;
a rasterizer transforming a plurality of primitives into a plurality of pixels; and
a visibility tester performing a visibility test based on triangle correlation information of the first primitive and the position information of the second primitive, and, prior to operating a rasterizer, removing the second primitive based on a result of the visibility test.

27. The data processing system of claim 26, wherein the position information of the first primitive comprises X, Y, and Z coordinates of each vertex of the first primitive, and
the position information of the second primitive comprises X, Y, and Z coordinates of each vertex of the second primitive.

28. The data processing system of 27, wherein the visibility tester determines whether the second primitive is included in the first primitive based on the position information of the second primitive and the position information and the triangle correlation information of the first primitive, and, when it is determined that the second primitive is included in the first primitive, compares the Z coordinates of the vertices of the first primitive with the Z coordinates of the vertices of the second primitive.

29. The data processing system of claim 26, further comprising:
an update determination unit determining whether the position information of the second primitive is to be stored in the visibility buffer based on the result of the visibility test; and
an update unit storing information regarding the second primitive in the visibility buffer based on a result of determining whether the position information of the second primitive is to be stored in the visibility buffer.

30. (canceled)
